(19) United States
(12) Patent Application Publication
(10) Pub. No.: US 2025/0265612 A1
(43) Pub. Date: Aug. 21, 2025

(54) PARKING RESERVATION METHOD IN URBAN CENTRAL BUSINESS DISTRICT BASED ON DYNAMIC PRICING

(71) Applicant: Chang'an University, Xi'an (CN)

(72) Inventors: Jian Sun, Xi'an (CN); Yunlong Li, Xi'an (CN); Kewei Yu, Xi'an (CN); Guo Qiu, Xi'an (CN); Qibo Zhang, Shanghai (CN)

(21) Appl. No.: 18/634,699

(22) Filed: Apr. 12, 2024

(30) Foreign Application Priority Data
Feb. 20, 2024 (CN) 202410185794.7

(51) Int. Cl. G06Q 30/0201; G06Q 10/02

(52) U.S. Cl. CPC G06Q 30/0206; G06Q 10/02

(57) ABSTRACT

The present invention relates to the technical field of transportation demand management and parking pricing, and specifically to a parking reservation method in the urban central business district based on dynamic pricing, comprising the following steps, S1, traffic data acquisition, S2, key value calibration, S3, perceived utility calculation, S4, parking probability measurement, and S5, pricing strategy realization. The method of reserving parking spaces in the CBD of this city is aimed at addressing the serious imbalance between the supply and demand of parking resources. To alleviate the problem of parking difficulties in urban CBD areas and appropriately increase the revenue of parking lots by dynamically adjusting parking costs. At the same time, this method greatly reduces the cruising time of vehicles when searching for parking spaces, effectively reduces fuel waste and exhaust emissions during cruising, and largely avoids traffic congestion caused by the convergence of cruising vehicles and through traffic.

### CROSS-REFERENCE TO RELATED APPLICATIONS

This application claims priority of Chinese Patent Application No. 202410185794. 7, filed on Feb. 20, 2024, the entire contents of which are incorporated herein by reference.

### TECHNICAL FIELD

The present invention relates to the technical field of transportation demand management and parking pricing, and specifically to parking reservation methods in urban central business districts based on dynamic pricing.

### BACKGROUND TECHNOLOGIES

With the continuous development and expansion of modern cities, the CBD area has become one of the most attractive and influential areas in the city. CBD area has a unique geographical advantage, not only gathering financial, commercial, and other industries but also has a comprehensive urban function. These functions have attracted a large number of people into the area, making the CBD area extremely high population density, while the traffic and pedestrian flow is also unusually large. However, due to the lack of density of transportation routes in the CBD area, the traffic flow is very huge, leading to increasingly prominent traffic congestion problems in the area.

At present, a large number of domestic and foreign studies and practices show that purely increasing parking supply cannot effectively solve the problem of urban parking difficulties, and parking fee pricing, as a key factor affecting parking demand, plays a prominent role in regulating urban parking demand. Ayala (2011) proposed a parking model based on the game theory, and based on this, he proposed a new parking allocation protocol, which has certain research significance and practical value for improving the parking lot's efficiency and reducing congestion, which has certain research significance and practical value. Guo (2013) proposed a parking choice model based on game theory and also pointed out that assuming that drivers make parking decisions at the same time, a Nash equilibrium can be derived and a better understanding of the decision-making behaviors of other drivers can be obtained.

The traffic congestion problem has become one of the important factors restricting the development and function realization of urban CBD areas, in the future, the parking problem in CBD areas will be more serious, and more effective measures need to be taken to alleviate the traffic pressure, therefore, it has an important theoretical significance and practical value to play the leverage role of the parking fee in the economy, and to establish a study on the method of booking the parking space of urban CBD based on the dynamic pricing The study of dynamic pricing based parking reservation method in urban CBD has important theoretical significance and practical value.

### CONTENT OF THE INVENTION

It is an object of the present invention to provide a parking reservation method in urban central business district based on dynamic pricing, to solve the problems raised in the above background art.

To realize the above purposes, the present invention provides the following technical solutions: a parking reservation method in urban central business district based on dynamic pricing. This includes the following steps:

### S1, Traffic Data Acquisition

Based on the data obtained from the field traffic survey, through the statistical and preliminary processing of the data, the travel cost, travel time consumption, and comfort level in the attributes of travel modes, the income level and travel purpose in the attributes of travelers, and the data on the number of parking spaces, charges, and geographic location in the allocation of parking resources were selected;

### S2, Key Value Calibration

The attributes of the two modes of travel studied, the car and public transportation, and the attributes of the different types of travelers were numerically calibrated, and the average values of all factors affecting travelers' trips other than the cost of parking were calculated, and the sensitivity of each type of traveler to the cost of the trip, the time spent on the trip, and the level of comfort were weighted according to the survey results, and the weighting matrix was determined;

### S3, Perceived Utility Calculation

Taking data calibration as the premise and prospect theory as the theoretical basis, and based on various types of travelers' psychological reference values for different modes of travel and the actual reference values of each mode of travel, we calculate the prospect values of travel cost, travel time consumption, and comfort level, and obtain the comprehensive perceived utility of various types of travelers for the modes of travel;

### S4, Parking Probability Measurement

Taking the binomial logit model as the model basis, to better describe the traveler's choice preference in choosing the travel mode, introducing the traveler's choice preference coefficient that can be calculated from the survey data, and synthesizing the perceived utility, determining the probability of parking choice;

### S5, Pricing Strategy Realization

Based on the parking selection probability, combined with the optimality principle in dynamic programming theory, the dynamic pricing strategy is determined based on the reserved parking volume, benchmark price, and constraints, and the solution principle is given.

Preferably, for the processing and analysis of traffic data, this is achieved by the following steps:

### S1. 1, Acquisition of Attribute Data for Two Modes of Travel, Car Trips, and Public Transportation Trips

Specific data needed include travel time consumption, travel costs, comfort levels, and total parking in the CBD area during the statistical study period;

### S1. 2, Acquisition of Traveler Attribute Data

Through the distribution of questionnaires to travelers, including their attributes, existing travel and travel intentions, and other aspects of the survey, including but not limited to age, gender, income level, the purpose of travel, the length of past trips, the purpose of past trips, the acceptance of dynamic tolls and so on;

S1. 3, Access to Parking Resource Allocation within the CBD Area

The researchers conducted a field survey of the parking lots in the area and conducted a detailed investigation of the rates and number of parking spaces in the parking lots, as well as the geographic location of the parking lots and the nature of the surrounding land use;

Preferably, the calibration for the key values is specifically achieved by the following steps:

### S2. 1, Influence Factor Calibration

Calibration of each travel influencing factors, to study the impact of parking costs on the travel mode of the traveler, for the out-of-parking costs other than the other influencing factors selected for the calculation of the average value of travel in the region, each type of traveler's three factors are two-by-two comparisons of the method of calculating the weights;

### S2. 2, Travel Mode Weighting Calibration

The weights of different types of travelers choosing different modes of travel are calibrated, based on the survey of travelers, through the correlation and significance test, to get the degree of sensitivity of different types of travelers or other factors to the three influencing factors, and then classify the travelers, and through the two-by-two comparison method for each type of travelers, the three factors are calculated by the two-by-two comparison method to calculate the weight, and use the sum and product method with the establishment of a matrix of weight coefficients through consistency test;

### S2. 3, Willingness Survey Data Processing

Determine the reference values of different types of travelers for the influencing factors, which are based on the mean values of different types of travelers for the survey data on their willingness to reserve parking.

Preferably, for perceived utility, this is specifically achieved by the following steps:

### S3. 1, Modeling of Travelers' Perceived Utility

For the traveler, the lower the travel cost, and travel time consumption, the more in line with the traveler's psychological expectations, when the actual travel costs, and travel time consumption are lower than the traveler's psychological expectations, the perceived utility for the gain, less than their psychological reference level for the positive utility, and vice versa for the negative utility, and the level of comfort and the opposite, the traveler's outlook on the various factors of the value of the formula for calculating the value is:

$${V}_{ji}^{Δ} = \{ \begin{matrix}{\vert ( {Δ}_{j}^{r} - {Δ}_{i} ) \vert}^{α} , {Δ}_{i} ⩽ {Δ}_{j}^{r} \\ - λ {\vert {Δ}_{i} - {Δ}_{j}^{r} \vert}^{α} , {Δ}_{i} > {Δ}_{j}^{r}\end{matrix} , i = 1 , 2 , j = 1 , 2$$

Where, Vⱼᵢ^{Δ} indicates the prospective value of each factor, Δ can be x, y, z, Δⱼ^{r} indicates traveler's psychological reference value for each factor, and the comfort level is taken as the opposite number, Δⱼ indicates actual reference value of each factor, and the comfort level is taken as the opposite number.

### S3. 2, Calculation of the Integrated Perceived Utility Matrix

Calculate the combined perceived utility matrix for each type of traveler for different modes of travel, and standardize the resulting traveler's outlook for each factor:

$${V}_{ji}^{Δ} = \frac{{V}_{ji}^{Δ} - {V}_{min}^{Δ}}{{V}_{max}^{Δ} - {V}_{min}^{Δ}} , i = 1 , 2 , j = 1 , 2$$

Where, Vⱼᵢ^{Δ} indicates the perceived utility of each factor, Vₘₐₓ^{Δ}, Vₘᵢₙ^{Δ} indicates the maximum and minimum values of the foreground values, respectively.

Multiplying the normalized prospect values with the weighting coefficients yields the perceived utility values of each traveler for the three factors:

Uⱼᵢ^{Δ}=Vⱼᵢ^{Δ}ωⱼ^{Δ},i=1,2,j=1,2

Where, Uⱼᵢ^{Δ} indicates the perceived utility of each factor, ωⱼ^{Δ} indicates the weight of perceived utility of each factor.

The perceived utilities of the three factors are then summed to obtain the combined perceived utility of each traveler for the mode of travel:

$$\begin{matrix}{U}_{ji} = {U}_{ji}^{x} + {U}_{ji}^{y} + {U}_{ji}^{z} + {ε}_{ji} \\ = {V}_{ji}^{x} {ω}_{j}^{x} + {V}_{ji}^{y} {ω}_{j}^{y} + {V}_{ji}^{z} {ω}_{j}^{x} + {ε}_{ji}\end{matrix}$$

Where, Uⱼᵢ indicates the combined perceived utility of each traveler for the mode of travel, εⱼᵢ indicates a random utility, including unmeasured components, computational errors, etc., that obeys a Gumbel distribution with zero mean, is independent and identically distributed and satisfies the IIA property.

Preferably, the parking probability measurement based on a binomial logit model is achieved by the following steps:

### S4. 1, Modified Binomial Logit Model

Introducing the traveler preference coefficient μ, the traveler preference coefficient is calculated from the survey data using the great likelihood method to find the value of;

### S4. 2, Calculation of Parking Probability

The probability that a traveler chooses a car trip and also chooses to park is derived from a modified binomial logit model:

$${P}_{j 1} = \frac{{e}^{μ {U}_{j 1}}}{{e}^{μ {U}_{j 1}} + {e}^{μ {U}_{j 2}}}$$

Where, μ indicates the traveler's preference coefficient, U indicates the perceived utility of different travelers choosing different modes of travel.

Preferably, the dynamic pricing strategy is realized by the following steps:

### S5. 1, Calculation of Reserved Parking Volume

Based on the parking probability and other data for the reservation of parked vehicles according to the following formula:

$${d}_{t}^{[ u - v ]} ( {\sum }_{i = u}^{v} {p}_{t}^{i} ) = {\sum }_{j = 1}^{2} ( {O}_{j , t}^{[ u - v ]} {P}_{carj , t}^{[ u - v ]} ( {\sum }_{i = u}^{v} {p}_{t}^{i} ) )$$

Where, pₜⁱ indicates the reservation parking price for the i^{th} parking slot in the t^{th} reservation slot, i=1, 2, . . . , N, zₜ indicates the number of parking spaces remaining in the parking lot at the beginning of the t^{th} reservation period, O_{j,t}^{[u-v]} a indicates the demand forecast for time period u-v generated in time period t, P_{carj,t}^{[u-v]}(Σᵢ₌ᵤ^{v}pₜⁱ) indicates the probability of choosing to travel by car.

S5. 2, Calculate the parking revenue of the parking lot, the parking space belongs to the perishable goods, the cost is fixed and the residual value is zero if it is not booked, it can be obtained that the parking lot revenue in the time period t is:

$$f = {\sum }_{u = 1}^{N} {\sum }_{v = u}^{N} ( {d}_{i}^{[ u - v ]} {\sum }_{i = u}^{v} {p}_{t}^{i} )$$

S5. 3, Given the model constraints, parking prices are regulated under government guidance, pricing should be no lower than the minimum pricing and no higher than the maximum pricing, and the price in the subsequent reservation period should be no lower than that in the previous reservation period:

$${p}^{L} ⩽ {p}_{t}^{h} ⩽ {p}^{U} , t = R , … 2 , 1 , h = 1 , 2 … N \\ {p}_{t}^{h} ⩽ {p}_{t - 1}^{h} , t = R , … , 2 , 1 , h = 1 , 2 , … , N$$

Where, p^{L} indicates the market-restricted minimum price, p^{U} indicates the market-restricted maximum price, and minimum and maximum prices are regulated by government guidelines, pₜ^{h} indicates the parking price for parking slot h^{th} at reservation slot t^{th}, pₜ₋₁^{h} indicates the parking price for parking slot h^{th} at reservation slot t−1^{th};

The number of vehicles remaining at the beginning of each reservation period satisfies the space constraints:

$$0 ⩽ {z}_{t - 1} ⩽ {z}_{t} , t = M … 2 , 1 , h = 1 , 2 … N$$

Where, zₜ₋₁ indicates the number of remaining parking spaces in time period t−1^{th}, zₜ indicates the number of remaining parking spaces in time period t−1^{th};

The total number of parking space reservations for each reservation period is not greater than the number of remaining parking spaces in the previous period (eₜ^{[u-v]} is an N-dimensional vector with items u through v being 1 and the rest being 0):

$${\sum }_{u = 1}^{N} {\sum }_{v = u}^{N} ( {d}_{i}^{[ u - v ]} {e}_{t}^{[ u - v ]} ) ⩽ {z}_{t}$$

The number of remaining spaces in time period t^{th} and time period t−1^{th} satisfy the following relationship:

$${z}_{t - 1} = {z}_{t} - {\sum }_{u = 1}^{N} {\sum }_{v = u}^{N} ( {d}_{t}^{[ u - v ]} {e}_{t}^{[ u - v ]} )$$

S5. 4, Given a dynamic programming model, the objective of dynamic programming is revenue maximization, it can be expressed as:

$${V}_{t} ( {z}_{t} , {p}_{t} ) = max \{ {\sum }_{u = 1}^{N} {\sum }_{v = u}^{N} ( {d}_{t}^{[ u - v ]} {\sum }_{i = u}^{v} {p}_{t}^{i} ) + {V}_{t - 1} ( {z}_{t - 1} ) \}$$

Boundary conditions are:

$${V}_{t} ( 0 ) = 0 \\ {V}_{0} ( {c}_{0} , {p}_{0} ) = max {\sum }_{u = 1}^{N} {\sum }_{v = u}^{N} ( {d}_{0}^{[ u - v ]} \times {\sum }_{i = u}^{v} {p}_{0}^{i} )$$

The solution principle is:

The decision variable of the model is the parking fee p, and the state variable is the number of remaining parking spaces in the parking lot z. Starting from the boundary conditions of the model, the optimal solution is obtained by gradual recursion from the back to the front, and the solution of each sub-problem is based on the result of the optimal decision of the previous problem, and according to the order of from the back to the front, the most optimal decision obtained from the problem is the optimal decision obtained from the whole problem when it is solved to the last problem:

The indicator function of the present invention takes the form of a sum of each stage as the sum of the indicators of each sub-stage, taking the form of a sum:

F_{t,0}=Σⱼ₌₀^{t}fⱼ(zⱼ,pⱼ)

Where, fⱼ(zⱼ, pⱼ) indicators for sub-stage j. The indicator function satisfies the three properties of the dynamic programming indicator function described above. Equation can also be expressed as:

$${F}_{t , 0} = {f}_{t} ( {z}_{t} , {p}_{t} ) {F}_{t - 1 , 0} [ {z}_{t - 1} , … , {z}_{0} ] \\ Where , \\ {z}_{t - 1} = {z}_{t} - {\sum }_{u = 1}^{N} {\sum }_{v = w}^{N} ( {d}_{t}^{[ u - v ]} {e}_{t}^{[ u - v ]} )$$

Given the initial state, the strategy and the indicator function are also determined, the indicator function is a function of the initial state and the strategy and is used to evaluate the effectiveness of the strategy, which can be denoted as F_{t, 0}[zₜ, u_{t, 0}(zₜ)]. Thus the above recurrence relation can be expressed as:

$${F}_{t , 0} = {f}_{t} ( {z}_{t} , {p}_{t} ) {F}_{t - 1 , 0} [ {z}_{t - 1} , {u}_{t - 1 , 0} ]$$

Sub-stage u_{t,0}(zₜ) can be seen as a combination of pₜ(zₜ) and u_{t-1,0}(zₜ_{⁻¹}) which leads to the equation:

$${u}_{t , 0} = \{ {p}_{t} ( {z}_{t} ) , {u}_{t - 1 , 0} ( {z}_{t - 1} ) \}$$

With u_{t,0}*(zₜ) representing the optimal sub-strategy among all sub-strategies obtained before the state is zₜ. So the optimal value function can be expressed as 25:

$${V}_{t} ( {z}_{t} ) = {F}_{t , 0} [ zt , {u}_{t , 0}^{*} ( {z}_{t} ) ] = {opt}_{{u}_{t , 0}} {F}_{t , 0} [ {z}_{t} , {u}_{t} ( {z}_{t} ) ] \\ But :$$

$$\begin{matrix}{opt}_{{u}_{t , n}} {F}_{t \cdot 0} [ {z}_{t} , {u}_{t , 0} ] = {opt}_{( {p}_{t} , {u}_{t - 1 , 0} )} \{ {f}_{t} ( {z}_{t} \cdot {p}_{t} ) + {F}_{t - 1 , 0} ( {z}_{t - 1} , {u}_{t - 1 , 0} ) \} \\ = {opt}_{{u}_{t}} \{ {p}_{t} ( {z}_{t} , {p}_{t} ) + {opt}_{{u}_{t - 1 , 0}} {F}_{t - 1 , 0} \}\end{matrix} \\ And :$$

$${V}_{t - 1} ( {z}_{t - 1} ) = {opt}_{{u}_{t - 1 , 0}} {F}_{t - 1 , 0} ( {z}_{t - 1} , {u}_{t - 1 , 0} ) \\ So : \\ {V}_{t} ( {z}_{t} ) = {opt}_{{p}_{t} ∈ {D}_{t} ( {z}_{t} )} [ {f}_{t} ( {z}_{t} , {p}_{t} ) + {v}_{{t}^{- 1}} ( {z}_{t - 1} ) ] , \\ t = 0 , 1 , … , R$$

The boundary conditions are:

$${V}_{t} ( 0 ) = 0 \\ {V}_{0} ( {z}_{0} , {p}_{0} ) = max [ {\sum }_{u = 1}^{N} {\sum }_{v = w}^{N} ( {d}_{0}^{[ u - z ]} \times {\sum }_{i = 1}^{v} {p}_{0}^{i} ) ]$$

This is the basic equation of dynamic programming inverse order solution, based on the given initial conditions, from the beginning, from the first time period to the R^{th} time period gradually solve to get the optimal results of each sub-stage, and finally solve to get V_{R}(z_{R}) is also V_{R}(c) when the final solution of the whole problem, that is, the optimal solution.

Compared with the prior art, the beneficial effects of the present invention are:

1. the city CBD parking space booking method, for China's parking resources supply and demand serious imbalance of the reality of the problem, through the dynamic adjustment of parking fees, to a certain extent, to alleviate the city CBD area “parking difficult” problem, to a certain extent, to improve the income of the parking lot.

2. The city CBD parking reservation method, the utilization rate of parking lots in the city CBD area will be maintained at a high level and, at the same time largely reduce the vehicle cruising time in search of parking spaces, effectively reducing the fuel waste and exhaust emissions in the process of cruising, and to a large extent avoid the traffic congestion caused by the convergence of cruising vehicles and through traffic.

### ILLUSTRATE WITH DIAGRAMS

To more clearly illustrate the technical solutions in the embodiments of the present invention, the accompanying drawings to be used in the description of the embodiments will be briefly introduced below, and it is obvious that the accompanying drawings in the following description are only some embodiments of the present invention, and that for the person of ordinary skill in the field, other accompanying drawings can be obtained according to these drawings under the premise of not exerting creative labor.

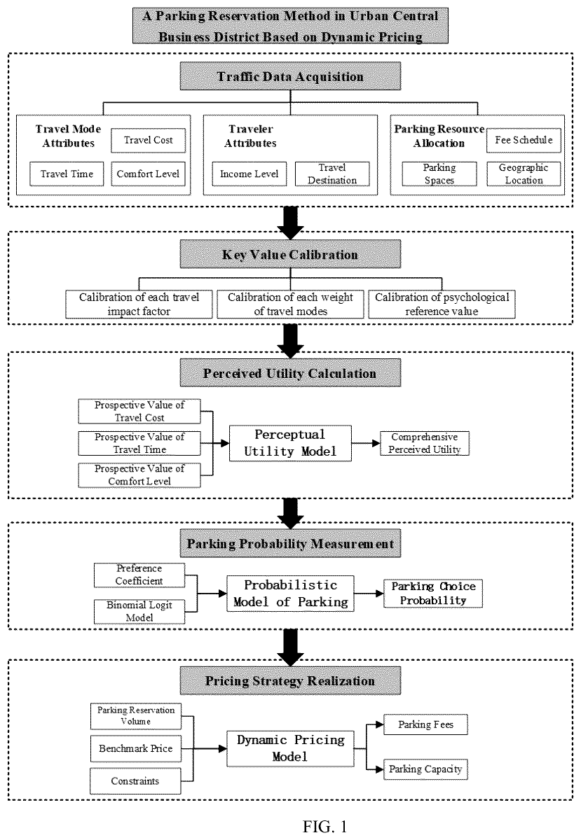

FIG. 1 shows a workflow diagram of the present invention;

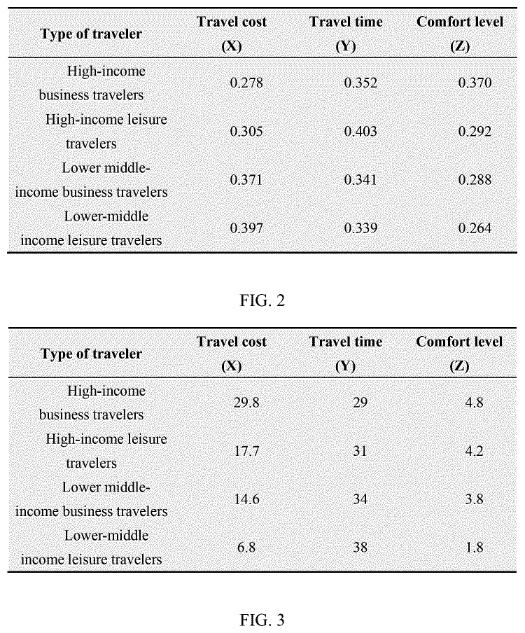

FIG. 2 shows a table of weights of different types of travelers for factors influencing travel;

FIG. 3 shows a table of reference values for different types of travelers for the three factors;

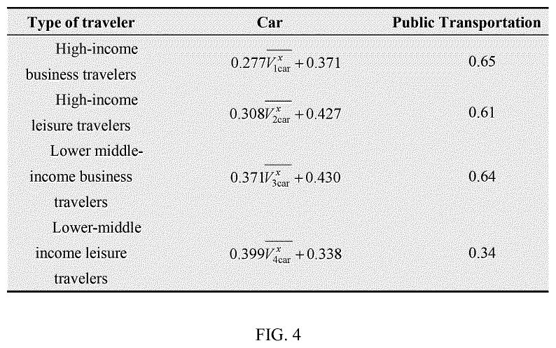

FIG. 4 shows the combined perceived utility matrix for different travelers.

### MODALITIES OF IMPLEMENTATION

The technical solutions in the embodiments of the present invention will be described clearly and completely in the following in connection with the embodiments of the present invention, and it is obvious that the described embodiments are only a part of the embodiments of the present invention and not all of the embodiments. Based on the embodiments in the present invention, all other embodiments obtained by a person of ordinary skill in the art without making creative labor are within the scope of protection of the present invention.

In the present invention, unless otherwise expressly provided and limited, the terms “mounting”, “connecting”, “connecting”, “fixing” and the like shall be broadly construed. The terms “mounted”, “connected”, “connected”, “fixed” and the like are to be understood in a broad sense, for example, it may be a fixed connection, a removable connection, or a one-piece connection; it may be a mechanical connection or an electrical connection; it may be a direct connection or an indirect connection through an intermediate medium, and it may be a connectivity within the two elements or an interaction between the two elements. For those of ordinary skill in the art, the specific meanings of the above terms in the present invention may be understood on a case-by-case basis.

Referring to FIGS. 1-4, the present invention provides the following technical solution:

A parking reservation method in urban central business district based on dynamic pricing, includes the following steps:

### S1, Traffic Data Acquisition

Based on the data obtained from the field traffic survey, through the statistical and preliminary processing of the data, the travel cost, travel time consumption, and comfort level in the attributes of travel modes, the income level and travel purpose in the attributes of travelers, and the data on the number of parking spaces, charges, and geographic location in the allocation of parking resources were selected;

### S2, Key Value Calibration

The attributes of the two modes of travel studied, the car and public transportation, and the attributes of the different types of travelers were numerically calibrated, and the average values of all factors affecting travelers' trips other than the cost of parking were calculated, and the sensitivity of each type of traveler to the cost of the trip, the time spent on the trip, and the level of comfort were weighted according to the survey results, and the weighting matrix was determined;

### S3, Perceived Utility Calculation

Taking data calibration as the premise and prospect theory as the theoretical basis, and based on various types of travelers' psychological reference values for different modes of travel and the actual reference values of each mode of travel, we calculate the prospect values of travel cost, travel time consumption, and comfort level, and obtain the comprehensive perceived utility of various types of travelers for the modes of travel;

### S4, Parking Probability Measurement

Taking the binomial logit model as the model basis, to better describe the traveler's choice preference in choosing the travel mode, introducing the traveler's choice preference coefficient that can be calculated from the survey data, and synthesizing the perceived utility, determining the probability of parking choice;

### S5, Pricing Strategy Realization

Based on the parking selection probability, combined with the optimality principle in dynamic programming theory, the dynamic pricing strategy is determined based on the reserved parking volume, benchmark price, and constraints, and the solution the principle is given.

For the processing and analysis of traffic data, this is achieved by the following steps:

### S1. 1, Acquisition of Attribute Data for Two Modes of Travel, Car Trips, and Public Transportation Trips

Specific data needed include travel time consumption, travel costs, comfort levels, and total parking in the CBD area during the statistical study period;

### S1. 2, Acquisition of Traveler Attribute Data

Through the distribution of questionnaires to travelers, including their attributes, existing travel and travel intentions, and other aspects of the survey, including but not limited to age, gender, income level, the purpose of travel, the length of past trips, the purpose of past trips, the acceptance of dynamic tolls and so on;

S1. 3, Access to Parking Resource Allocation within the CBD Area

The researchers conducted a field survey of the parking lots in the area and conducted a detailed investigation of the rates and number of parking spaces in the parking lots, as well as the geographic location of the parking lots and the nature of the surrounding land use;

The calibration for the key values is specifically achieved by the following steps:

### S2. 1, Influence Factor Calibration

Calibration of each travel influencing factors, to study the impact of parking costs on the travel mode of the traveler, for the out-of-parking costs other than the other influencing factors selected for the calculation of the average value of travel in the region, each type of traveler's three factors are two-by-two comparisons of the method of calculating the weights;

### S2. 2, Travel Mode Weighting Calibration

The weights of different types of travelers choosing different modes of travel are calibrated, based on the survey of travelers, through the correlation and significance test, to get the degree of sensitivity of different types of travelers or other factors to the three influencing factors, and then classify the travelers, and through the two-by-two comparison method for each type of travelers, the three factors are calculated by the two-by-two comparison method to calculate the weight, and use the sum and product method with the establishment of a matrix of weight coefficients through consistency test;

### S2. 3, Willingness Survey Data Processing

Determine the reference values of different types of travelers for the influencing factors, which are based on the mean values of different types of travelers for the survey data on their willingness to reserve parking.

Perceived utility, is specifically achieved by the following steps:

### S3. 1, Modeling of Travelers' Perceived Utility

For the traveler, the lower the travel cost, and travel time consumption, the more in line with the traveler's psychological expectations, when the actual travel costs, and travel time consumption are lower than the traveler's psychological expectations, the perceived utility for the gain, less than their psychological reference level for the positive utility, and vice versa for the negative utility, and the level of comfort and the opposite, the traveler's outlook on the various factors of the value of the formula for calculating the value is:

$${V}_{ji}^{Δ} = \{ \begin{matrix}{\vert ( {Δ}_{j}^{r} - {Δ}_{i} ) \vert}^{α} , & {Δ}_{i} ⩽ {Δ}_{j}^{r} \\ - λ {\vert {Δ}_{i} - {Δ}_{j}^{r} \vert}^{α} , & {Δ}_{i} > {Δ}_{j}^{r}\end{matrix} , \\ i = 1 , 2 , j = 1 , 2$$

Where, Vⱼᵢ^{Δ} indicates the prospective value of each factor, Δ can be x, y, z, Δⱼ^{r} indicates traveler's psychological reference value for each factor, and the comfort level is taken as the opposite number, Δⱼ indicates actual reference value of each factor and the comfort level is taken as the opposite number.

### S3. 2, Calculation of the Integrated Perceived Utility Matrix

Calculate the combined perceived utility matrix for each type of traveler for different modes of travel, and standardize the resulting traveler's outlook for each factor:

$${\overline{V}}_{ji}^{Δ} = \frac{{V}_{ji}^{Δ} - {V}_{min}^{Δ}}{{V}_{max}^{Δ} - {V}_{min}^{Δ}} , \\ i = 1 , 2 , j = 1 , 2$$

Where, Vⱼᵢ^{Δ} indicates the perceived utility of each factor, Vₘₐₓ^{Δ}, Vₘᵢₙ^{Δ} indicates the maximum and minimum values of the foreground values, respectively.

Multiplying the normalized prospect values with the weighting coefficients yields the perceived utility values of each traveler for the three factors:

Uⱼᵢ^{Δ}=Vⱼᵢ^{Δ}ωⱼ^{Δ},i=1,2,j=1,2

Where, Uⱼᵢ^{Δ} indicates the perceived utility of each factor, ωⱼ^{Δ} indicates the weight of perceived utility of each factor.

The perceived utilities of the three factors are then summed to obtain the combined perceived utility of each traveler for the mode of travel:

$$\begin{matrix}{U}_{ji} = {U}_{ji}^{x} + {U}_{ji}^{y} + {U}_{ji}^{z} + {ε}_{ji} \\ = {\overline{V}}_{ji}^{x} {ω}_{j}^{x} + {\overline{V}}_{ji}^{y} {ω}_{j}^{y} + {\overline{V}}_{ji}^{z} {ω}_{j}^{x} + {ε}_{ji}\end{matrix}$$

Where, Uⱼᵢ indicates the combined perceived utility of each traveler for the mode of travel, εⱼᵢ indicates a random utility, including unmeasured components, computational errors, etc., that obeys a Gumbel distribution with zero mean, is independent and identically distributed and satisfies the IIA property.

The parking probability measurement based on a binomial logit model is achieved by the following steps:

### S4. 1, Modified Binomial Logit Model

Introducing the traveler preference coefficient μ, the traveler preference coefficient is calculated from the survey data using the great likelihood method to find the value of;

### S4. 2, Calculation of Parking Probability

The probability that a traveler chooses a car trip and also chooses to park is derived from a modified binomial logit model:

$${P}_{j 1} = \frac{{e}^{μ {U}_{j 1}}}{{e}^{μ {U}_{j 1}} + {e}^{μ {U}_{j 2}}}$$

Where, μ indicates the traveler's preference coefficient, U indicates the perceived utility of different travelers choosing different modes of travel.

The dynamic pricing strategy is realized by the following steps:

### S5. 1, Calculation of Reserved Parking Volume

Based on the parking probability and other data for the reservation of parked vehicles according to the following formula:

$${d}_{t}^{[ u - v ]} ( {\sum }_{i = u}^{v} {p}_{t}^{i} ) = {\sum }_{j = 1}^{2} ( {O}_{j , t}^{[ u - v ]} {P}_{carj , t}^{[ u - v ]} ( {\sum }_{i = u}^{v} {p}_{t}^{i} ) )$$

Where, pₜⁱ indicates the reservation parking price for the i^{th} parking slot in the t^{th} reservation slot, i=1, 2, . . . , N, zₜ indicates the number of parking spaces remaining in the parking lot at the beginning of the t^{th} reservation period, O_{j,t}^{[u-v]} a indicates the demand forecast for time period u-v generated in time period t, p_{carj,t}^{[u-v]}(Σᵢ₌ᵤ^{v}pₜⁱ) indicates the probability of choosing to travel by car.

S5. 2, Calculate the parking revenue of the parking lot, the parking space belongs to the perishable goods, the cost is fixed and the residual value is zero if it is not booked, it can be obtained that the parking lot revenue in the time period t is:

$$f = {\sum }_{u = 1}^{N} {\sum }_{v = u}^{N} ( {d}_{i}^{[ u - v ]} {\sum }_{i = u}^{v} {p}_{t}^{i} )$$

S5.3, Given the model constraints, parking prices are regulated under government guidance, pricing should be no lower than the minimum pricing and no higher than the maximum pricing, and the price in the subsequent reservation period should be no lower than that in the previous reservation period:

$${p}^{L} ⩽ {p}_{t}^{h} ⩽ {p}^{U} , t = R , … 2 , 1 , h = 1 , 2 … N \\ {p}_{t}^{h} ⩽ {p}_{t - 1}^{h} , t = R , … , 2 , 1 , h = 1 , 2 , … , N$$

Where, p^{L} indicates the market-restricted minimum price, p^{U} indicates the market-restricted maximum price, and minimum and maximum prices are regulated by government guidelines, pₜ^{h} indicates the parking price for parking slot h^{th} at reservation slot t^{th}, pₜ₋₁^{h} indicates the parking price for parking slot h^{th} at reservation slot t−1^{th};

The number of vehicles remaining at the beginning of each reservation period satisfies the space constraints:

$$0 ⩽ {z}_{t - 1} ⩽ {z}_{t} , t = M … 2 , 1 , h = 1 , 2 … N$$

Where, zₜ₋₁ indicates the number of remaining parking spaces in time period t−1^{th}, zₜ indicates the number of remaining parking spaces in time period t−1^{th};

The total number of parking space reservations for each reservation period is not greater than the number of remaining parking spaces in the previous period (eₜ^{[u-v]} is an N-dimensional vector with items u through v being 1 and the rest being 0):

$${\sum }_{u = 1}^{N} {\sum }_{v = u}^{N} ( {d}_{i}^{[ u - v ]} {e}_{t}^{[ u - v ]} ) ⩽ {z}_{t}$$

The number of remaining spaces in time period t^{th} and time period t−1^{th} satisfy the following relationship:

$${z}_{t - 1} = {z}_{t} - {\sum }^{N} {\sum }_{V U}^{N} ( {d}_{t}^{[ u - v ]} {e}_{t}^{[ u - v ]} )$$

S5.4, Given a dynamic programming model, the objective of dynamic programming is revenue maximization, it can be expressed as:

$${V}_{t} ( {z}_{t} , {p}_{t} ) = max \{ {\sum }_{u = 1}^{N} {\sum }_{v = u}^{N} ( {d}_{t}^{[ u - v ]} {\sum }_{i = u}^{v} {p}_{t}^{i} ) + {v}_{t - 1} ( {z}_{t - 1} ) \}$$

Boundary conditions are:

$${V}_{t} ( 0 ) = 0 \\ {V}_{0} ( {c}_{0} , {p}_{0} ) = max {\sum }_{u = 1}^{N} {\sum }_{v = u}^{N} ( {d}_{0}^{[ u - v ]} \times {\sum }_{i = u}^{v} {p}_{0}^{i} )$$

The solution principle is:

The decision variable of the model is the parking fee p, and the state variable is the number of remaining parking spaces in the parking lot z. Starting from the boundary conditions of the model, the optimal solution is obtained by gradual recursion from the back to the front, and the solution of each sub-problem is based on the result of the optimal decision of the previous problem, and according to the order of from the back to the front, the most optimal decision obtained from the problem is the optimal decision obtained from the whole problem when it is solved to the last problem:

The indicator function of the present invention takes the form of a sum of each stage as the sum of the indicators of each sub-stage, taking the form of a sum:

F_{t,0}=Σⱼ₌₀^{t}fⱼ(zⱼ,pⱼ)

Where, fⱼ(zⱼ,pⱼ) indicators for sub-stage j. The indicator function satisfies the three properties of the dynamic programming indicator function described above. Equation can also be expressed as:

$${F}_{t , 0} = {f}_{t} ( {z}_{t} , {p}_{t} ) {F}_{t - 1 , 0} [ {z}_{t - 1} , … , {z}_{0} ] \\ Where , {z}_{t - 1} = {z}_{t} - {\sum }_{u = 1}^{N} {\sum }_{v = w}^{N} ( {d}_{t}^{[ u - v ]} {e}_{t}^{[ u - v ]} )$$

Given the initial state, the strategy and the indicator function are also determined, the indicator function is a function of the initial state and the strategy and is used to evaluate the effectiveness of the strategy, which can be denoted as F_{t, 0}[zₜ, u_{t, 0}(zₜ)]. Thus the above recurrence relation can be expressed as:

$${F}_{t , 0} = {f}_{t} ( {z}_{t} , {p}_{t} ) {F}_{t - 1 , 0} [ {z}_{t - 1} , {u}_{t - 1 , 0} ]$$

Sub-stage u_{t,0}(zₜ) can be seen as a combination of pₜ(zₜ) and u_{t-1,0}(zₜ_{⁻¹}) which leads to the equation:

$${u}_{t , 0} = \{ {P}_{t} ( {z}_{t} ) , {u}_{t - 1 , 0} ( {z}_{t - 1} ) \}$$

With u_{t,0}*(zₜ) representing the optimal sub-strategy among all sub-strategies obtained before the state is zₜ. So the optimal value function can be expressed as 25:

$${V}_{t} ( {z}_{t} ) = {F}_{t , 0} [ {z}_{t} , {u}_{t , 0}^{*} ( {z}_{t} ) ] = {opt}_{{u}_{t , 0}} {F}_{t , 0} [ {z}_{t} , {u}_{t} ( {z}_{t} ) ] \\ But : \\ \begin{matrix}{opt}_{{u}_{t , n}} {F}_{t \cdot 0} [ {z}_{t} , {u}_{t , 0} ] = {opt}_{( {p}_{t} , {u}_{t - 1 , 0} )} \{ {f}_{t} ( {z}_{t} \cdot {p}_{t} ) + {F}_{t - 1 , 0} ( {z}_{t - 1} , {u}_{t - 1 , 0} ) \} \\ = {opt}_{{u}_{t}} \{ {p}_{t} ( {z}_{t} , {p}_{t} ) + {opt}_{{u}_{t - 1 , 0}} {F}_{t - 1 , 0} \} \\ And :\end{matrix}$$

$${V}_{t - 1} ( {z}_{t - 1} ) = {opt}_{{u}_{t - 1 , 0}} {F}_{t - 1 , 0} ( {z}_{t - 1} , {u}_{t - 1 , 0} ) \\ So : \\ {V}_{t} ( {z}_{t} ) = {opt}_{{p}_{t} ∈ {D}_{t} ( {z}_{t} )} [ {f}_{t} ( {z}_{t} , {p}_{t} ) + {v}_{{t}^{- 1}} ( {z}_{t - 1} ) ] , t = 0 , 1 , … , R$$

The boundary conditions are:

$${V}_{t} ( 0 ) = 0 \\ {V}_{0} ( {z}_{0} , {p}_{0} ) = max [ {\sum }_{u = 1}^{N} {\sum }_{v = w}^{N} ( {d}_{0}^{[ u - z ]} \times {\sum }_{i = 1}^{v} {p}_{0}^{i} ) ]$$

This is the basic equation of dynamic programming inverse order solution, based on the given initial conditions, from the beginning, from the first time period to the R^{th} time period gradually solve to get the optimal results of each sub-stage, and finally solve to get V_{R}(z_{R}) is also V_{R}(c) when the final solution of the whole problem, that is, the optimal solution.

It is to be noted that, in this document, relational terms such as first and second are used only to distinguish one entity or operation from another, and do not necessarily require or imply any such actual relationship or order between those entities or operations. Furthermore, the terms “including”, “comprising”, or any other variant thereof, are intended to cover non-exclusive inclusion, such that a process, method, article, or apparatus comprising a set of elements includes not only those elements, but also other elements not expressly listed, or other elements that are not expressly listed for such a process, method, article or apparatus, or other elements that are not expressly listed for such a process, method, article or equipment. elements, or also includes elements that are inherent to such process, method, article, or apparatus. Without further limitation, the elements limited by the statement “including a . . . ” do not preclude the existence of additional identical elements in the process, method, article, or apparatus comprising said elements.

Although embodiments of the present invention have been shown and described, it will be appreciated by those of ordinary skill in the art that a variety of changes, modifications, substitutions, and variations may be made to these embodiments without departing from the principle and spirit of the present invention and that the scope of the present invention is limited by the appended claims and their equivalents.

1. A parking reservation method in an urban central business district (CBD) based on dynamic pricing, characterized as comprising:
based on data obtained from a field traffic survey, through statistical and preliminary processing of the data, selecting a travel cost, travel time consumption, and comfort level in attributes of travel modes, an income level and travel purpose in the attributes of travelers, and the data on the number of parking spaces, charges, and geographic location in an allocation of parking resources;
numerically calibrating attributes of two modes of travel studied, car and public transportation, and attributes of different types of travelers, and calculating average values of all factors affecting travelers' trips other than a cost of parking, and weighting a sensitivity of each type of traveler to a cost of the trip, a time spent on the trip, and the level of comfort according to survey results, and determining a weighting matrix;
taking data calibration as a premise and prospect theory as a theoretical basis, and based on various types of travelers' psychological reference values for different modes of travel and actual reference values of each mode of travel, calculating prospect values of the travel cost, the travel time consumption, and the comfort level, and obtaining a comprehensive perceived utility of various types of travelers for the modes of travel;
taking a binomial logit model as a model basis, to better describe the traveler's choice preference in choosing the travel mode, introducing the traveler's choice preference coefficient that can be calculated from survey data, and synthesizing the perceived utility, determining a probability of parking choice;
based on the probability of parking choice, combined with an optimality principle in a dynamic programming theory, determining a dynamic pricing strategy based on a reserved parking volume, a benchmark price, and constraints, and giving a solution principle;
performing parking pricing according to the dynamic pricing strategy;
wherein the based on data obtained from a field traffic survey, through statistical and preliminary processing of the data, selecting a travel cost, travel time consumption, and comfort level in attributes of travel modes, an income level and travel purpose in the attributes of travelers, and the data on the number of parking spaces, charges, and geographic location in an allocation of parking resources, comprises:
acquiring attribute data for two modes of travel, car trips, and public transportation trips, wherein specific data needed include travel time consumption, travel costs, comfort levels, and total parking in the CBD area during the statistical study period;
acquiring, through the distribution of questionnaires to travelers, their attributes, existing travel and travel intentions of the survey, including age, gender, income level, the purpose of travel, the length of past trips, the purpose of past trips, the acceptance of dynamic tolls;
performing a field survey of the parking lots in the area and conducted a detailed investigation of the rates and number of parking spaces in the parking lots, as well as the geographic location of the parking lots and the nature of the surrounding land use;
wherein the numerically calibrating attributes of two modes of travel studied, car and public transportation, and attributes of different types of travelers, and calculating average values of all factors affecting travelers' trips other than a cost of parking, and weighting a sensitivity of each type of traveler to a cost of the trip, a time spent on the trip, and the level of comfort according to survey results, and determining a weighting matrix, comprises:
performing calibration of each travel influencing factors, to study the impact of parking costs on the travel mode of the traveler, for the out-of-parking costs other than the other influencing factors selected for the calculation of the average value of travel in the region, each type of traveler's three factors are two-by-two comparisons of the method of calculating the weights;
calibrating the weights of different types of travelers choosing different modes of travel, based on the survey of travelers, through the correlation and significance test, to get the degree of sensitivity of different types of travelers or other factors to the three influencing factors, and then classifying the travelers, and through the two-by-two comparison method for each type of travelers, the three factors are calculated by the two-by-two comparison method to calculate the weight, and using the sum and product method with the establishment of a matrix of weight coefficients through consistency test;
determining the reference values of different types of travelers for the influencing factors, which are based on the mean values of different types of travelers for the survey data on their willingness to reserve parking;
wherein the taking data calibration as a premise and prospect theory as a theoretical basis, and based on various types of travelers' psychological reference values for different modes of travel and actual reference values of each mode of travel, calculating prospect values of the travel cost, the travel time consumption, and the comfort level, and obtaining a comprehensive perceived utility of various types of travelers for the modes of travel, comprises:
modeling travelers' perceived utility, based on following:
for the traveler, the lower the travel cost, and travel time consumption, the more in line with the traveler's psychological expectations, when the actual travel costs, and travel time consumption are lower than the traveler's psychological expectations, the perceived utility for the gain, less than their psychological reference level for the positive utility, and vice versa for the negative utility, and the comfort level and the opposite, the traveler's outlook on the various factors of the value of the formula for calculating the value is:
$${V}_{ji}^{Δ} = \{ \begin{matrix}{\vert ( {Δ}_{j}^{r} - {Δ}_{i} ) \vert}^{α} , {Δ}_{i} ⩽ {Δ}_{j}^{r} \\ - λ {\vert {Δ}_{i} - {Δ}_{j}^{r} \vert}^{α} , {Δ}_{i} > {Δ}_{j}^{r}\end{matrix} , i = 1 , 2 , j = 1 , 2$$
where, Vⱼᵢ^{Δ} indicates the prospective value of each factor, Δ can be x, y, z, Δⱼ^{r} indicates traveler's psychological reference value for each factor, and the comfort level is taken as the opposite number, Δⱼ indicates actual reference value of each factor, and the comfort level is taken as the opposite number;
calculating the combined perceived utility matrix for each type of traveler for different modes of travel, and standardize the resulting traveler's outlook for each factor:
$${V}_{ji}^{Δ} = \frac{{V}_{ji}^{Δ} - {V}_{min}^{Δ}}{{V}_{max}^{Δ} - {V}_{min}^{Δ}} , i = 1 , 2 , j = 1 , 2$$
where, Vⱼᵢ^{Δ} indicates the perceived utility of each factor, Vₘₐₓ^{Δ}, Vₘᵢₙ^{Δ} indicates the maximum and minimum values of the foreground values, respectively;
multiplying the normalized prospect values with the weighting coefficients yields the perceived utility values of each traveler for the three factors:
$${U}_{ji}^{Δ} = {V}_{ji}^{Δ} {ω}_{j}^{Δ} , i = 1 , 2 , j = 1 , 2$$
where, Uⱼᵢ^{Δ} indicates the perceived utility of each factor, ωⱼ^{Δ} indicates the weight of perceived utility of each factor;
summing the perceived utilities of the three factors to obtain the combined perceived utility of each traveler for the mode of travel:
$$\frac{{U}_{ji} = {U}_{ji}^{x} + {U}_{ji}^{y} + {U}_{ji}^{z} + {ε}_{ji}}{= {V}_{ji}^{x} {ω}_{j}^{x} + {V}_{ji}^{y} {ω}_{j}^{y} + {V}_{ji}^{z} {ω}_{j}^{x} + {ε}_{ji}}$$
where, Uⱼᵢ indicates the combined perceived utility of each traveler for the mode of travel, εⱼᵢ indicates a random utility, including unmeasured components, computational errors, that obeys a Gumbel distribution with zero mean, is independent and identically distributed and satisfies the IIA property;
wherein the taking a binomial logit model as a model basis, to better describe the traveler's choice preference in choosing the travel mode, introducing the traveler's choice preference coefficient that can be calculated from survey data, and synthesizing the perceived utility, determining a probability of parking choice, comprises:
introducing the traveler preference coefficient μ, the traveler preference coefficient is calculated from the survey data using the great likelihood method to find the value of;
deriving the probability that a traveler chooses a car trip and also chooses to park from a modified binomial logit model:
$${P}_{j 1} = \frac{{e}^{μ {U}_{j 1}}}{{e}^{μ {U}_{j 1}} + {e}^{μ {U}_{j 2}}}$$
where, μ indicates the traveler's preference coefficient, U indicates the perceived utility of different travelers choosing different modes of travel;
wherein the based on the probability of parking choice, combined with an optimality principle in a dynamic programming theory, determining a dynamic pricing strategy based on a reserved parking volume, a benchmark price, and constraints, and giving a solution principle, comprises:
calculating reserved parking volume based on the parking probability and other data for the reservation of parked vehicles according to the following formula:
$${d}_{t}^{[ u - v ]} ( {\sum }_{i = u}^{v} {p}_{t}^{i} ) = {\sum }_{j = 1}^{2} ( {O}_{j , t}^{[ u - v ]} {P}_{car j , t}^{[ u - v ]} ( {\sum }_{i = u}^{v} {p}_{t}^{i} ) )$$
where, pₜⁱ indicates the reservation parking price for the i^{th} parking slot in the t^{th} reservation slot, i=1, 2, . . . , N, zₜ indicates the number of parking spaces remaining in the parking lot at the beginning of the t^{th} reservation period, O_{j,t}^{[u-v]} a indicates the demand forecast for time period u-v generated in time period t, P_{carj,t}^{[u-v]}(Σᵢ₋ᵤ^{v}pₜⁱ) indicates the probability of choosing to travel by car;
calculating the parking revenue of the parking lot, the parking space belongs to the perishable goods, the cost is fixed and the residual value is zero if it is not booked, it can be obtained that the parking lot revenue in the period t is:
$$f = {\sum }_{u = 1}^{N} {\sum }_{v = u}^{N} ( {d}_{i}^{[ u - v ]} {\sum }_{i = u}^{v} {p}_{t}^{i} )$$
giving the model constraints, parking prices are regulated under government guidance, pricing should be no lower than the minimum pricing and no higher than the maximum pricing, and the price in the subsequent reservation period should be no lower than that in the previous reservation period:
$$\begin{matrix}{p}^{L} ⩽ {p}_{t}^{h} ⩽ {p}^{U} , t = R , … 2 , 1 , h = 1 , 2 … N \\ {p}_{t}^{h} ⩽ {p}_{t - 1}^{h} , t = R , … , 2 , 1 , h = 1 , 2 , … , N\end{matrix}$$
where, p^{L} indicates the market restricted minimum price, p^{U} indicates the market-restricted maximum price, and minimum and maximum prices are regulated by government guidelines, pₜ^{h} indicates the parking price for parking slot h^{th} at reservation slot t^{th}, pₜ₋₁^{h} indicates the parking price for parking slot h^{th} at reservation slot t−1^{th};
the number of vehicles remaining at the beginning of each reservation period satisfies the space constraints:
$$0 ⩽ {z}_{t - 1} ⩽ {z}_{t} , t = M … 2 , 1 , h = 1 , 2 … N$$
where, zₜ₋₁ indicates the number of remaining parking spaces in time period t−1^{th}, zₜ indicates the number of remaining parking spaces in time period t−1^{th};
the total number of parking space reservations for each reservation period is not greater than the number of remaining parking spaces in the previous period(eₜ^{[u-v]} is an N-dimensional vector with items u through v being 1 and the rest being 0):
$${\sum }_{u = 1}^{N} {\sum }_{v = u}^{N} ( {d}_{i}^{[ u - v ]} {e}_{t}^{[ μ - v ]} ) ⩽ {z}_{t}$$
the number of remaining spaces in time period t^{th} and time period t−1^{th} satisfy the following relationship:
$${z}_{t - 1} = {z}_{t} - {\sum }_{u = 1}^{N} {\sum }_{v = u}^{N} ( {d}_{t}^{[ u - v ]} {e}_{t}^{[ μ - v ]} )$$
giving a dynamic programming model, the objective of dynamic programming is revenue maximization, it can be expressed as:
$${V}_{t} ( {z}_{t} , {p}_{t} ) = max \{ {\sum }_{u = 1}^{N} {\sum }_{v = u}^{N} ( {d}_{t}^{[ u - v ]} {\sum }_{i = u}^{v} {p}_{t}^{i} ) + {V}_{t - 1} ( {z}_{t - 1} ) \}$$
boundary conditions are:
$$\begin{matrix}{V}_{t} ( 0 ) = 0 \\ {V}_{0} ( {c}_{0} , {p}_{0} ) = max {\sum }_{u = 1}^{N} {\sum }_{v = u}^{N} ( {d}_{0}^{[ u - v ]} \times {\sum }_{i = u}^{v} {p}_{0}^{i} )\end{matrix}$$
the solution principle is:
the decision variable of the model is the parking fee p, and the state variable is the number of remaining parking spaces in the parking lot z; starting from the boundary conditions of the model, the optimal solution is obtained by gradual recursion from the back to the front, and the solution of each sub-problem is based on the result of the optimal decision of the previous problem, and according to the order of from the back to the front, the most optimal decision obtained from the problem is the optimal decision obtained from the whole problem when it is solved to the last problem:
the indicator function takes the form of a sum of each stage as the sum of the indicators of each sub-stage, taking the form of a sum:
$${F}_{t , 0} = {\sum }_{j = 0}^{t} {f}_{i} ( {z}_{j} , {p}_{j} )$$
where, fⱼ(zⱼ, pⱼ) indicators for sub-stage j; the indicator function satisfies the three properties of the dynamic programming indicator function described above; the equation can also be expressed as:
$${F}_{t , 0} = {f}_{t} ( {z}_{t} , {p}_{t} ) {F}_{t - 1 , 0} [ {z}_{t - 1} , … , {z}_{0} ]$$
$$where ,$$
$${z}_{t - 1} = {z}_{t} - {\sum }_{u = 1}^{N} {\sum }_{v = w}^{N} ( {d}_{t}^{[ u - v ]} {e}_{t}^{[ μ - v ]} )$$
given the initial state, the strategy and the indicator function are also determined, the indicator function is a function of the initial state and the strategy and is used to evaluate the effectiveness of the strategy, which can be denoted as F_{t, 0}[zₜ, u_{t, 0}(zₜ)]; thus the above recurrence relation can be expressed as:
$${F}_{t , 0} = {f}_{t} ( {z}_{t} , {p}_{t} ) {F}_{t - 1 , 0} [ {z}_{t - 1} , {u}_{t - 1 , 0} ]$$
sub-stage u_{t,0}(zₜ) can be seen as a combination of pₜ(zₜ) and u_{t-1,0}(zₜ_{⁻¹}) which leads to the equation:
$${u}_{t , 0} = \{ {P}_{t} ( {z}_{t} ) , {u}_{t - 1 , 0} ( {z}_{t - 1} ) \}$$
with u_{t,0}*(zₜ) representing the optimal sub-strategy among all sub-strategies obtained before the state is zₜ; so the optimal value function can be expressed as 25:
$${V}_{t} ( {z}_{t} ) = {F}_{t , 0} [ {z}_{t} , {u}_{t , 0}^{*} ) ] = {opt}_{{u}_{t , 0}} {F}_{t , 0} [ {z}_{t} , {u}_{t} ( {z}_{t} ) ]$$
$$but :$$
$$\frac{{opt}_{{u}_{t , n}} {F}_{t \cdot 0} [ {z}_{t} , {u}_{t , 0} ] = {opt}_{( {p}_{t} , {u}_{t - 1 , 0} )} \{ {f}_{t} ( {z}_{t} \cdot {p}_{t} ) + {F}_{t - 1 , 0} ( {z}_{t - 1} , {u}_{t - 1 , 0} ) \}}{= {opt}_{{u}_{t}} \{ {p}_{t} ( {z}_{t} , {p}_{t} ) + {opt}_{{u}_{t - 1 , 0}} {F}_{t - 1 , 0} \}}$$
$$and :$$
$${V}_{t - 1} ( {z}_{t - 1} ) = {opt}_{{u}_{t - 1 , 0}} {F}_{t - 1 , 0} ( {z}_{t - 1} , {u}_{t - 1 , 0} )$$
$$so :$$
$${V}_{t} ( {z}_{t} ) = {opt}_{{p}_{t} ∈ {D}_{t} ( {z}_{t} )} [ {f}_{t} ( {z}_{t} , {p}_{t} ) + {v}_{t - 1} ( {z}_{t - 1} ) ] , t = 0 , 1 , … , R$$
the boundary conditions are:
$$\begin{matrix}{V}_{t} ( 0 ) = 0 \\ {V}_{0} ( {z}_{0} , {p}_{0} ) = max [ {\sum }_{u = 1}^{N} {\sum }_{v = w}^{N} ( {d}_{0}^{[ u - z ]} \times {\sum }_{i = 1}^{v} {p}_{0}^{i} ) ]\end{matrix}$$
this is the basic equation of dynamic programming inverse order solution, based on the given initial conditions, from the beginning, from the first time period to the R^{th} time period gradually solve to get the optimal results of each sub-stage, and finally solve to get V_{R}(z_{R}) is also V_{R}(c) when the final solution of the whole problem, that is, the optimal solution.

2.-6. (canceled)
